(19) United States
(12) Patent Application Publication
(10) Pub. No.: US 2018/0341070 A1
(43) Pub. Date: Nov. 29, 2018

(54) BOOT FOR A FIBER OPTIC CONNECTOR

(71) Applicant: Amphenol Fiber Optic Technology (Shenzhen) Co., Ltd., Shenzhen City (CN)

(72) Inventors: Junbei YAN, Shenzhen City (CN); Songsheng LI, Shenzhen City (CN); Min CHEN, Shenzhen City (CN)

(21) Appl. No.: 15/792,261

(22) Filed: Oct. 24, 2017

(30) Foreign Application Priority Data
May 25, 2017 (TW) 106207470

(51) Int. Cl. G02B 6/38

(52) U.S. Cl. CPC G02B 6/3887; G02B 6/3885

(57) ABSTRACT

A boot includes an inner sleeve unit and outer sleeve unit removably sleeved around the inner sleeve unit. The inner sleeve unit includes an inner sleeve body and a fiber-positioning member disposed in the inner sleeve body. The fiber-positioning member has an inclined insertion surface that faces a rear end of the inner sleeve body and that extends inclinedly and forwardly to a front end of the inner sleeve body, and a plurality of spaced apart positioning holes extending through the inclined insertion surface. The inclined insertion surface is inclined with respect to an extension direction of the positioning holes.

### CROSS-REFERENCE TO RELATED APPLICATION

This application claims priority to Taiwanese Patent Application No. 106207470, filed on May 25, 2017.

### FIELD

The disclosure relates to a boot, and more particularly to a boot for a fiber optic connector.

### BACKGROUND

FIG. 1 illustrates an existing boot 1 of a fiber optic cable connector for insertion of a multi-fiber optic cable 2 that has a plurality of fibers 21. The boot 1 includes a boot body 10 having an accommodating space 100, and a fiber-positioning member 11 disposed in the accommodating space 100 and having an insertion surface 111 perpendicular to a longitudinal direction (L) of the boot body 10. The fiber-positioning member 11 has a plurality of spaced apart positioning holes 110 extending through the insertion surface 111 for insertion of the fibers 21. After the insertion of fibers 21 is completed, the boot 1 is connected to a fiber optic cable connector (not shown).

Referring to FIG. 2, in combination with FIG. 1, because the insertion surface 111 of the fiber-positioning member 11 is perpendicular to the longitudinal direction (L) of the boot body 10, the viewing angle of the positioning holes 110 is limited and is inconvenient to precisely insert all of the fibers 21 of the multi-fiber optic cable 2 into the respective positioning holes 110 at the same time. As a result, some of the fibers 21 may be misaligned with the respective positioning holes 110 as shown in FIG. 2. Using the existing boot 1 with such misaligned fibers may adversely affect deployment of fiber optic communication networks.

### SUMMARY

Therefore, an object of the disclosure is to provide a boot for a fiber optic cable connector, which facilitates insertion of a multi-fiber optic cable.

According to the disclosure, a boot fora fiber optic connector includes an inner sleeve unit extending along a longitudinal direction of the boot, and an outer sleeve unit removably sleeved around the inner sleeve.

The inner sleeve unit includes an inner sleeve body, a tubular extension and a fiber-positioning member.

The inner sleeve body has a front end, a rear end and an accommodating space between front and rear ends.

The tubular extension extends integrally and rearward from the rear end of the inner sleeve body. The tubular extension has a passage communicating with the accommodating space.

The fiber-positioning member is disposed in the accommodating space and transverse to the longitudinal direction. The fiber-positioning member has an inclined insertion surface that faces the rear end of the inner sleeve body and that extends inclinedly and forwardly to the front end of the inner sleeve body, and a plurality of spaced apart positioning holes extending through the inclined insertion surface. The inclined insertion surface is inclined with respect to an extension direction of the positioning holes.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of an existing boot for a fiber optic cable connector;

FIG. 2 is a schematic view, illustrating a fiber-positioning member of the existing boot and fibers of a multi-fiber optic cable misaligned with positioning holes of the fiber-positioning member;

FIG. 3 is an exploded perspective view of a boot according to an embodiment of the present disclosure;

FIG. 4 is a side sectional view of the embodiment, illustrating an inner sleeve unit of the boot;

FIG. 5 is a top sectional view from FIG. 4; FIG. 6 is a rear view of the embodiment, illustrating the inner sleeve unit;

FIG. 7 is a perspective view of the embodiment, illustrating a multi-fiber optic cable inserted into the inner sleeve unit;

FIG. 8 is a sectional view of the embodiment, illustrating fibers of the multi-fiber optic cable aligned with positioning holes of a fiber-positioning member of the inner sleeve unit;

FIG. 9 is a sectional view of the embodiment, illustrating an inclined insertion surface inclined with respect to an extension direction of the positioning holes of the fiber-positioning member;

FIG. 10 is perspective view of the embodiment, illustrating an outer sleeve unit of the boot;

FIG. 11 is a top sectional view of the embodiment, illustrating the outer sleeve unit sleeved on the inner sleeve unit;

FIG. 12 is a perspective view of the embodiment, illustrating the outer sleeve unit having a removable tail sleeve; and

FIG. 13 is a sectional view of the embodiment, illustrating a needle injecting glue into the boot.

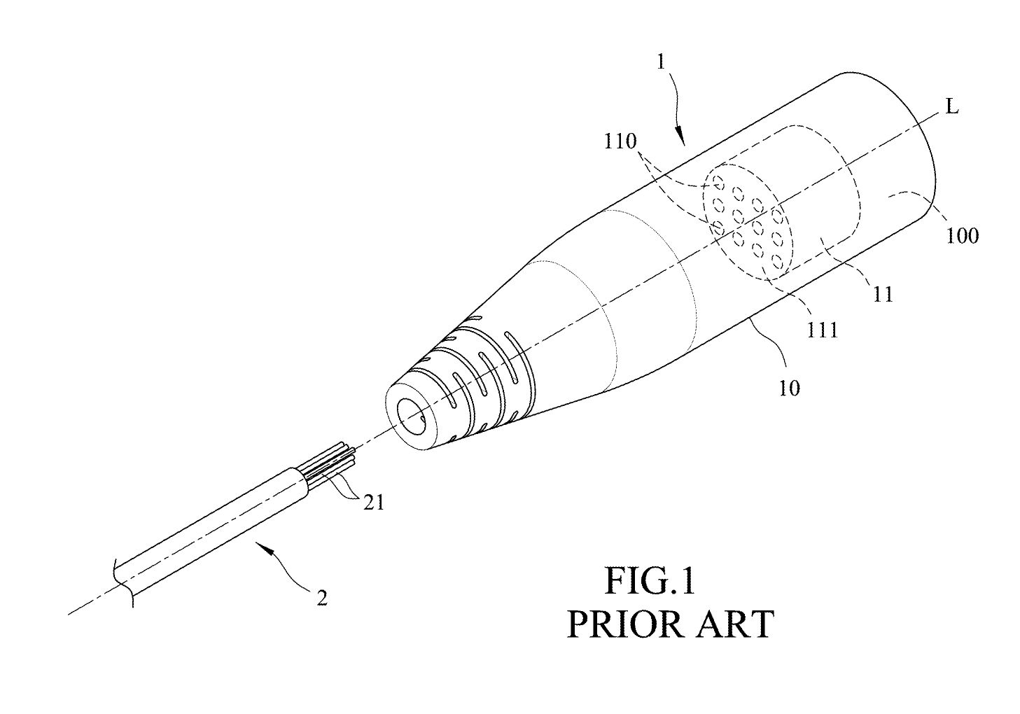

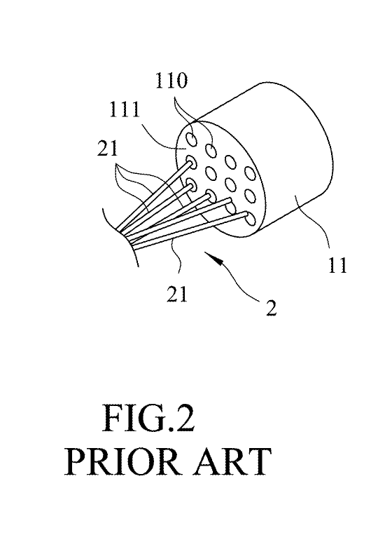

### DETAILED DESCRIPTION

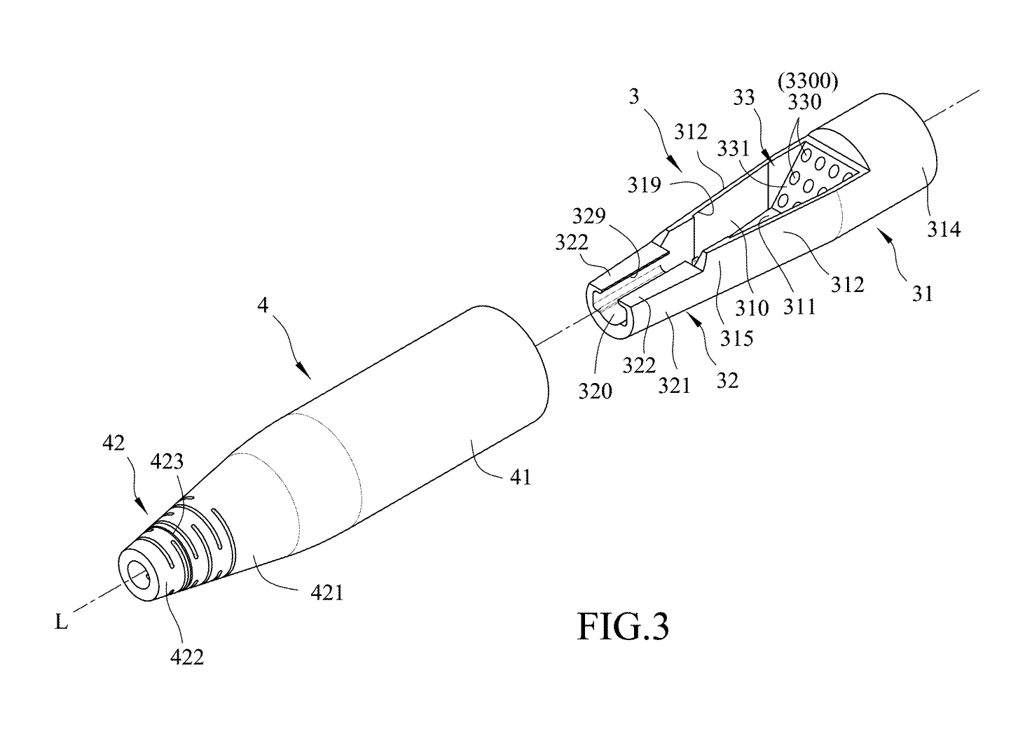

Referring to FIG. 3, a boot for a fiber optic cable connector according to an embodiment of the present disclosure is shown. The boot includes an inner sleeve unit 3 and an outer sleeve unit 4 removably sleeved around the inner sleeve unit 3.

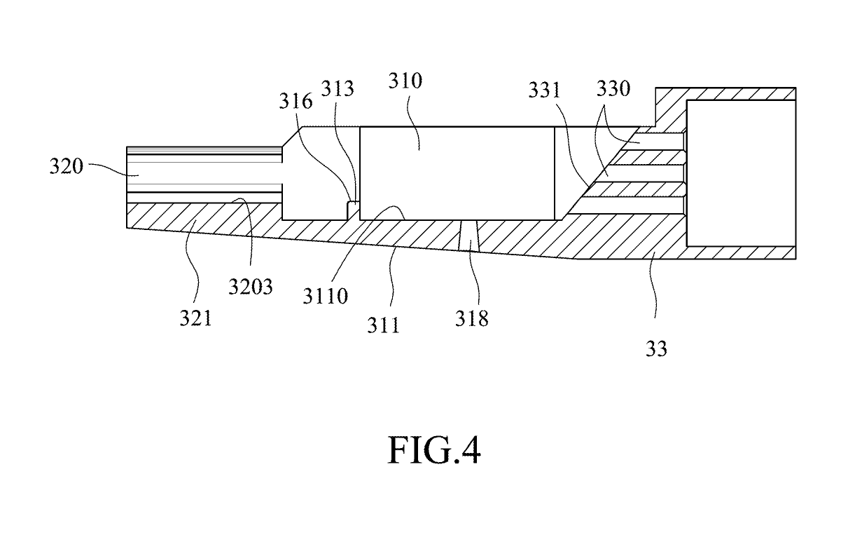

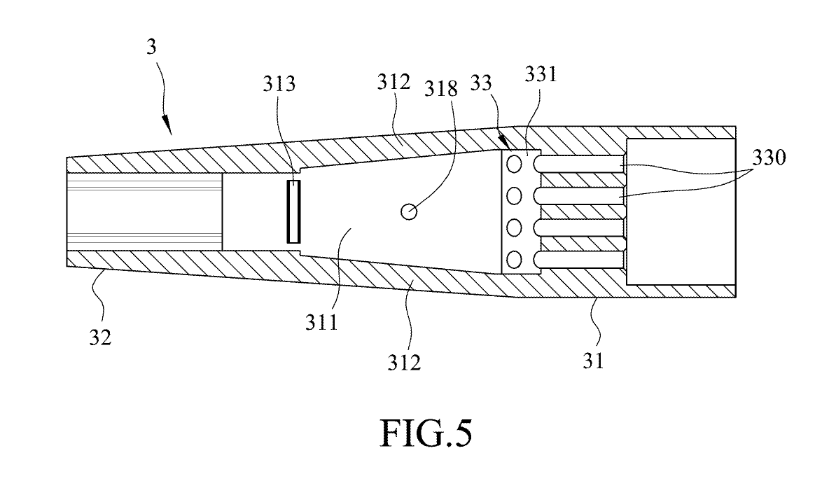

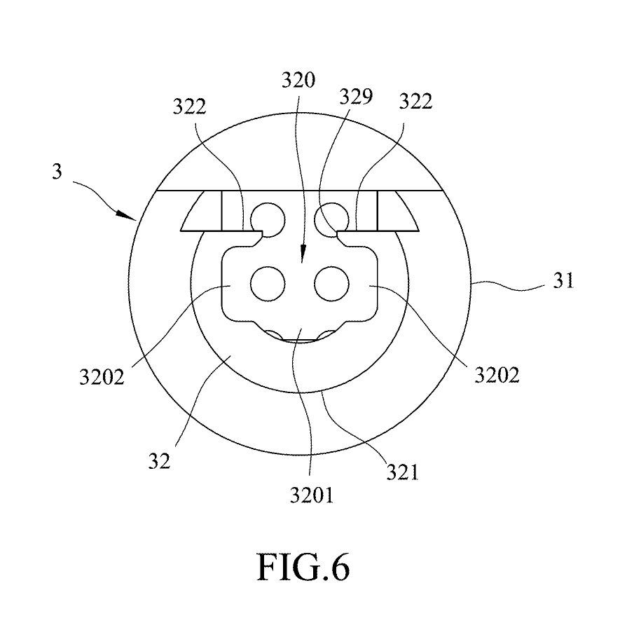

Referring to FIGS. 4 and 5, in combination with FIG. 3, the inner sleeve unit 3 extending along a longitudinal direction (L) of the boot, and includes an inner sleeve body 31, a tubular extension 32 and a fiber-positioning member 33. The inner sleeve body 31 has a front end 314, a rear end 315 and an accommodating space 310 between front and rear ends 314, 315. The inner sleeve body 31 further has a base plate portion 311, two side plate portions 312, a supporting portion 313 and an injection hole 318. The side plate portions 312 extend respectively from two opposite sides of the base plate portion 311 and cooperate with the base plate portion 311 to define the accommodating space 310. The supporting portion 313 projects from an inner surface 3110 of the base plate portion 311 into the accommodating space 310. The injection hole 318 extends through the base plate portion 311 and communicates with the accommodating space 310. The accommodating space 310 has an opening 319 formed between the side plate portions 312 oppositely of the base plate portion 311.

Referring to FIG. 6, in combination with FIGS. 3 and 4, the tubular extension 32 extends integrally and rearward from the rear end 315 of the inner sleeve body 31. As shown in FIG. 4, an inner surface 3203 of the tubular extension 32 is higher than the inner surface 3110 of the base plate portion 311. The supporting portion 313 of the sleeve body 31 has a top end 316 that is flush with the inner surface 3203. The tubular extension 32 has an arcuate plate portion 321 connected to the base plate portion 311 and the side plate portions 312, and two flat plate portions 322 respectively projecting toward each other from two opposite sides of the arcuate plate portion 321. The arcuate plate portion 321 and the flat plate portions 322 cooperatively define a passage 320 communicating with the accommodating space 310. The passage 320 has a longitudinally extending intermediate portion 3201 having a rounded cross section, and two longitudinally extending lateral portions 3202 disposed at two opposite sides of the intermediate portion 3201. Each lateral portion 3202 has a rectangular cross section. The flat plate portions 322 are spaced apart from each other and bound therebetween a passage opening 329 communicating with the passage 320.

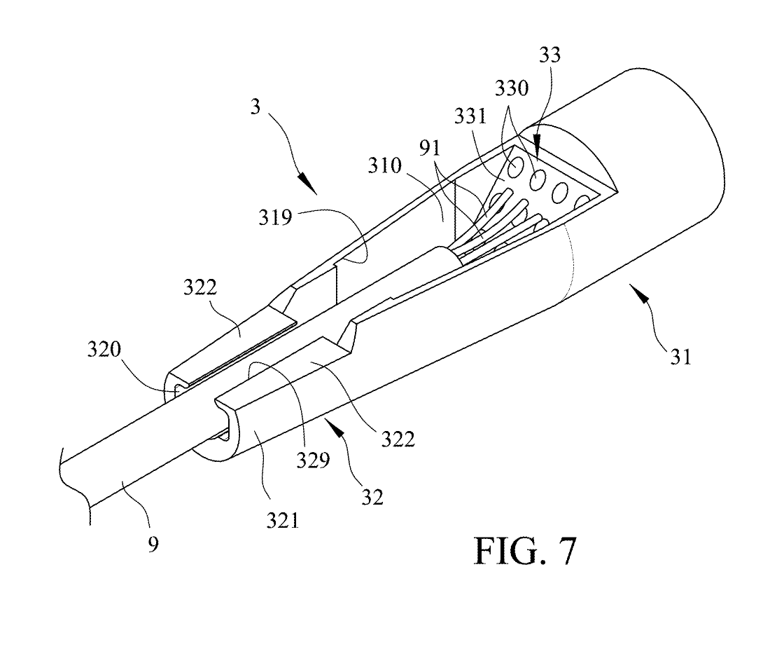

Referring FIG. 7, in combination with FIGS. 3 to 5, the fiber-positioning member 33 is disposed in the accommodating space 310 and transverse to the longitudinal direction (L). The fiber-positioning member 33 has an inclined insertion surface 331 that faces the rear end 315 of the inner sleeve body 31 and that extends inclinedly and forwardly to the front end 314 of the inner sleeve body 31, and a plurality of spaced apart positioning holes 330 extending through the inclined insertion surface 331. The inclined insertion surface 331 is inclined with respect to an extension direction of the positioning holes 330 and is inclined forwardly and upwardly from the base plate portion 311 to the opening 319. Each positioning hole 330 has an inlet 3300. The inlets 3300 of the positioning holes 330 are arranged in rows in the inclined insertion surface 331. Each row of the inlets 3300 extends transversely to the longitudinal direction (L). A multi-fiber optic cable 9 has a plurality of fibers 91 inserted into the positioning holes 330 through the inlets 3300, respectively. During assembly of the multi-fiber optic cable 9 with the boot of the present disclosure, the multi-fiber optic cable 9 is inserted into the accommodating space 310 of the inner sleeve body 31 through the passage 320 of the tubular extension 32.

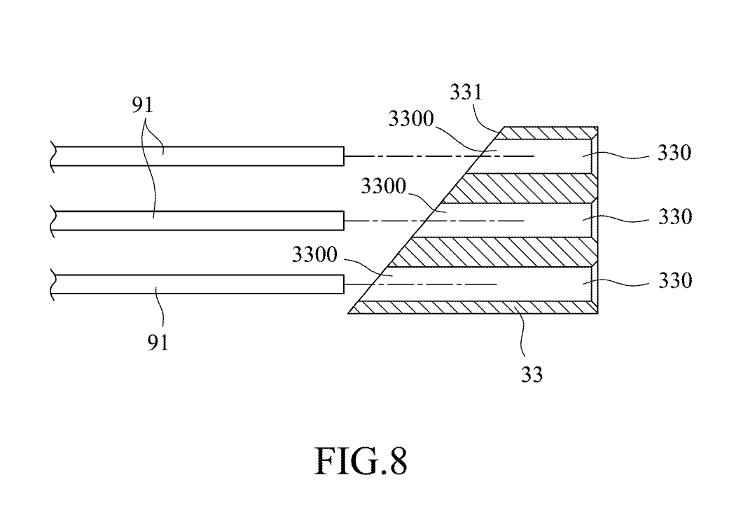

Referring to FIG. 8, unlike the prior art that requires all of the fibers 91 of the multi-fiber optic cable 9 to be inserted simultaneously into the positioning holes, the boot of the present disclosure having the inclined insertion surface 331 allows the fibers 91 to be inserted into the positioning holes 330 by one row after the other row. Since the number of the fibers 91 needed to simultaneously enter the positioning holes 330 is reduced, the process of inserting the fibers 91 becomes relatively easy.

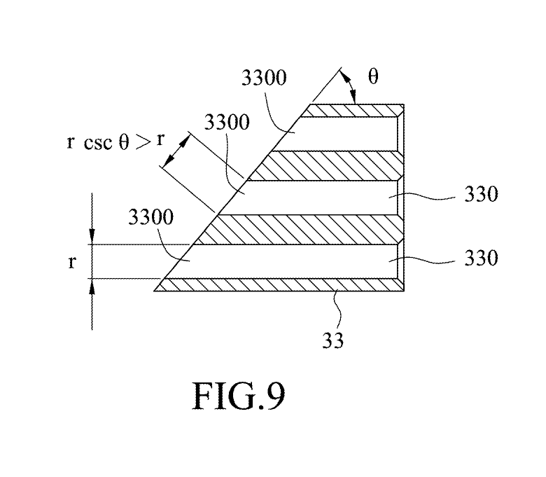

Referring to FIG. 9, for ensuring that each fiber 91 passes through a respective one of the positioning holes 330, each positioning hole 330 has a diameter (γ) equal to or slightly greater than that of each fiber 91. In this embodiment, the inclined insertion surface 331 is inclined at angle (θ) with respect to the extension direction of the positioning holes 330 so that each positioning hole 330 is beveled at the inclined insertion surface 331. Therefore, the width of each positioning hole 330 at the inclined insertion surface 331 is equal to γ cscθ, where cscθ>1. In other words, the width of the inlet 3300 of each positioning hole 330 is greater than that of each fiber 91, so that each fiber 91 can be easily inserted into the respective positioning hole 330 through the inlet 3300. Because the entire amount of the fibers 91 need not be simultaneously inserted into the positioning holes 330, and because the inlet 3300 of each positioning hole 330 is wider than each fiber 91, the fiber-positioning member 33 allows easy insertion of the fibers 91 thereinto.

Referring back to FIG. 7, because the accommodating space 310 has the opening 319, not only can the activity of inserting the fibers 91 be observed through the opening 319, but also additional aid for inserting the fibers may be provided through the opening 319 when necessary.

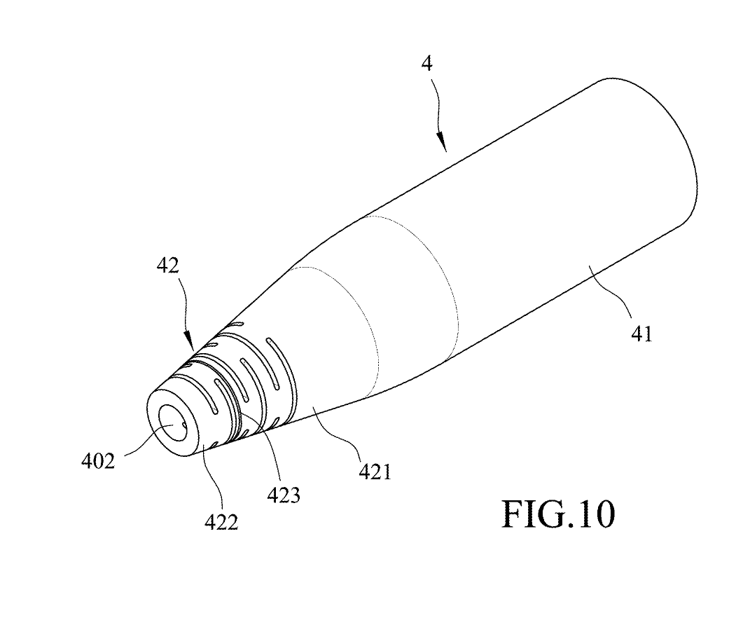

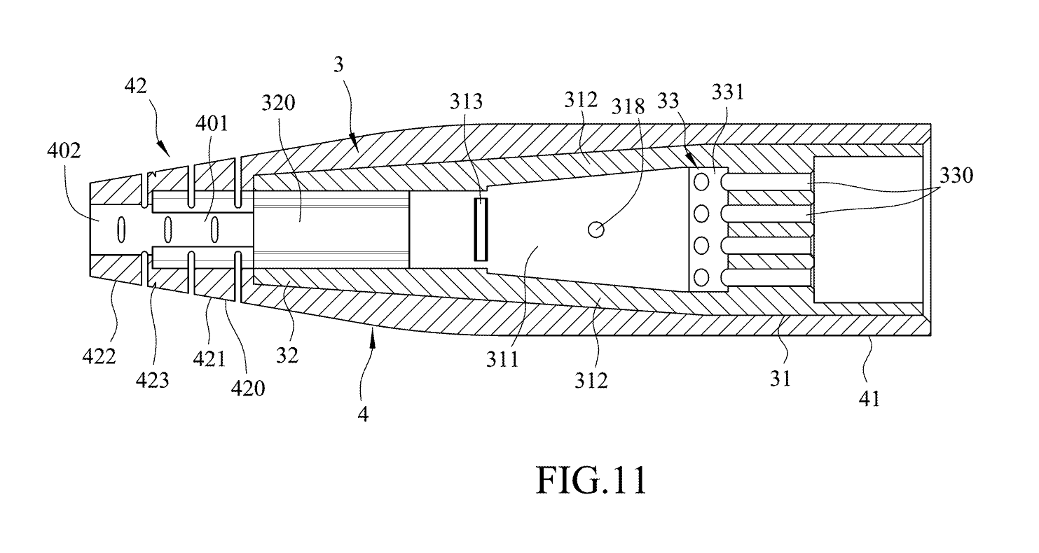

Referring to FIGS. 10 and 11, the outer sleeve unit 4 includes an outer sleeve 41 sleeved on the inner sleeve body 31 and the tubular extension 32, and a tail sleeve 42 extending rearward and integrally from the outer sleeve 41. The tail sleeve 42 has a front portion 421, and a rear portion 422 removably connected to the front portion 421. The front portion 421 has a ribbon fiber optic cable passage 401 conforming in cross section to the passage 320 of the tubular extension 32. The rear portion 422 has a round fiber optic cable passage 402 communicating with the ribbon fiber optic cable passage 401. In addition, the tail sleeve 42 further has an outer surface 420 formed with an indicator line 423 between the front and rear portions 421, 422.

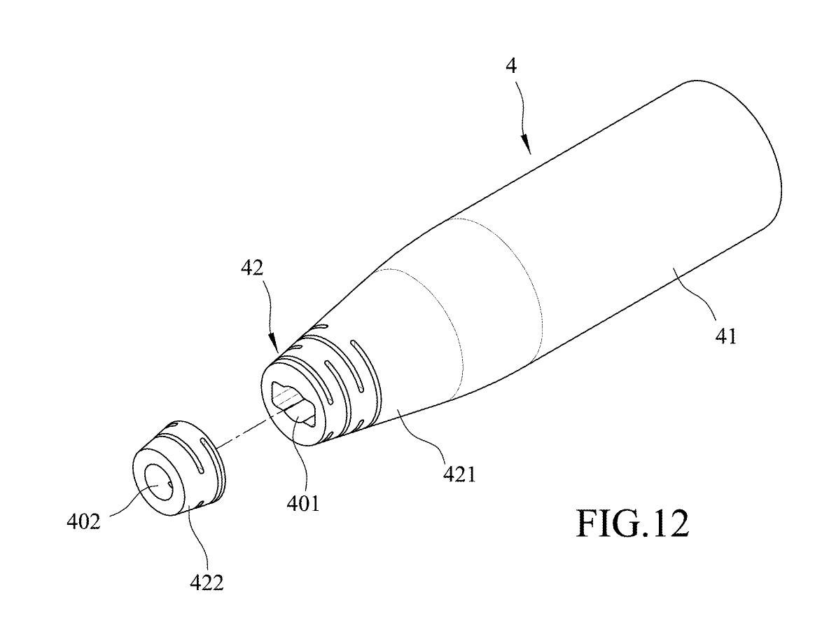

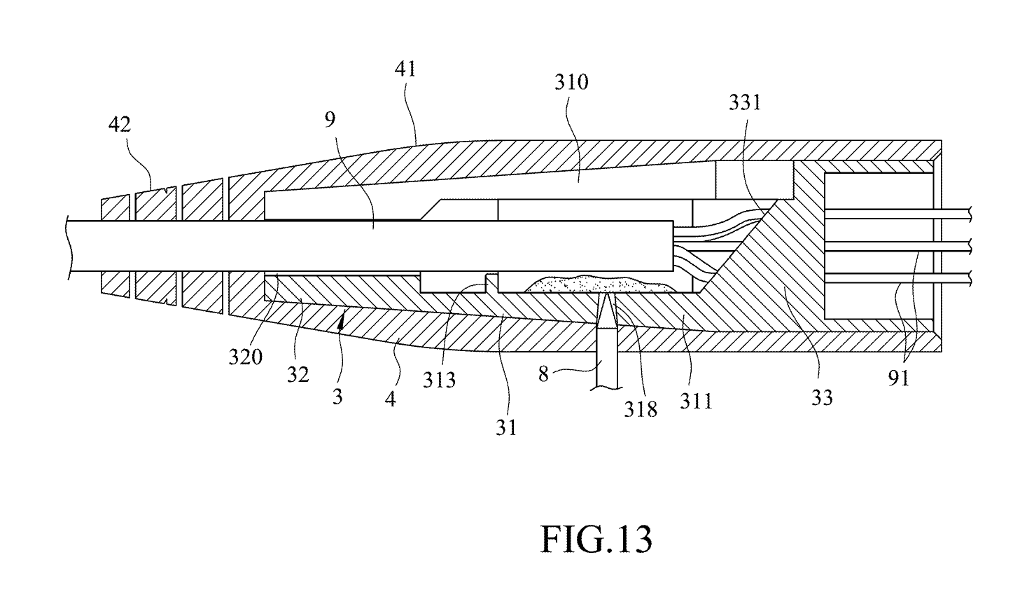

Referring to FIGS. 12 and 13, in combination with FIG. 6, when the multi-fiber optic cable 9 is a round cable, the rounded cross section of the intermediate portion 3201 of the passage 32 allows the multi-fiber optic cable 9 to pass therethrough. The round cable is also allowed to extend through the ribbon fiber optic cable passage 401 and the round fiber optic cable passage 402. When the multi-fiber optic cable 9 is a ribbon cable, the lateral portions 3202 and the intermediate portion 3201 of the passage 32 allow the multi-fiber optic cable 9 to pass therethrough. The ribbon cable is also allowed to extend through the ribbon fiber optic cable passage 401. To prevent the round fiber optic cable passage 402 from impeding the insertion of the multi-fiber optic cable 9, the rear portion 422 can be cut off along the indicator line 423 (see FIG. 10).

As shown in FIG. 13, the multi-fiber optic cable 9 is stably supported and positioned by the tail sleeve 42, the supporting portion 313 of the inner sleeve body 31, and the fiber-positioning member 33. To prevent the multi-fiber optic cable 9 from longitudinally sliding, a needle 8 is used to penetrate the outer sleeve unit 4 and to inject glue into the accommodating space 310 through the injection hole 318 of the inner sleeve body 31. The multi-fiber optic cable 9 is therefore assuredly positioned in the accommodating space 310 by the glue. Specifically, the injection hole 318 has a diameter that prevents the needle 8 from passing through the injection hole 318 into the accommodating space 310. Therefore, the needle 8 is prevented from damaging the multi-fiber optic cable 9.

By virtue of the structural arrangement of the inner sleeve body 31 and the fiber-positioning member 33, the process of inserting and positioning the fibers 91 of the multi-fiber optic cable 9 may be facilitated and the efficiency of fiber optic communication network deployment may be improved effectively.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

1. A boot for a fiber optic connector comprising:
an inner sleeve unit extending along a longitudinal direction of the boot and including
an inner sleeve body having a front end, a rear end and an accommodating space between front and rear ends,
a tubular extension extending integrally and rearward from said rear end of said inner sleeve body, said tubular extension having a passage communicating with said accommodating space, and
a fiber-positioning member disposed in said accommodating space and transverse to the longitudinal direction, said fiber-positioning member having an inclined insertion surface that faces said rear end of said inner sleeve body and that extends inclinedly and forwardly to said front end of said inner sleeve body, and a plurality of spaced apart positioning holes extending through said inclined insertion surface, said inclined insertion surface being inclined with respect to a plane perpendicular to an extension direction of said positioning holes, which extends along the longitudinal direction; and
an outer sleeve unit removably sleeved around said inner sleeve unit.

2. The boot as claimed in claim 1, wherein said inner sleeve body further has a base plate portion, and two side plate portions extending respectively from two opposite sides of said base plate portion and cooperating with said base plate portion to define said accommodating space, said accommodating space having an opening formed between said side plate portions oppositely of said base plate portion, said inclined insertion surface slanting forwardly toward said front end of said inner sleeve body from said base plate portion to said opening such that said inclined insertion surface gradually diverges from said rear end of said inner sleeve body in a direction from said base plate portion to said opening.

3. (canceled)

4. The boot as claimed in claim 2, wherein said inner sleeve body further has an injection hole extending through said base plate portion and communicating with said accommodating space.

5. The boot as claimed in claim 2, wherein said inner sleeve body further has a supporting portion projecting from an inner surface of said base plate portion into said accommodating space, said tubular extension having an inner surface higher than said inner surface of said base plate portion, said supporting portion having a top end flush with said inner surface of said tubular extension.

6. The boot as claimed in claim 2, wherein said passage of said tubular extension has an longitudinally extending intermediate portion having a rounded cross section, and two longitudinally extending lateral portions disposed at two opposite sides of said intermediate portion, each of said lateral portions having a rectangular cross section.

7. The boot as claimed in claim 2, wherein said tubular extension further has an arcuate plate portion connected to said base plate portion and said side plate portions, and two flat plate portions respectively projecting toward each other from two opposite sides of said arcuate plate portion, said arcuate plate portion and said flat plate portions cooperatively defining said passage, said flat plate portions being spaced apart from each other and bounding therebetween a passage opening communicating with said passage.

8. The boot as claimed in claim 1, said outer sleeve unit includes an outer sleeve sleeved on said inner sleeve body and said tubular extension, and a tail sleeve extending rearward and integrally from said outer sleeve.

9. The boot as claimed in claim 8, wherein said tail sleeve has a front portion, and a rear portion removably connected to said front portion, said front portion having a ribbon fiber optic cable passage conforming in cross section to said passage of said tubular extension, said rear portion having a round fiber optic cable passage communicating with said ribbon fiber optic cable passage.

10. The boot as claimed in claim 9, wherein said tail sleeve further has an outer surface formed with an indicator line between said front and rear portions.

11. The boot as claimed in claim 2, wherein said positioning holes are arranged in multiple rows disposed one above the other from said base plate portion to said opening, each of said rows lying on a plane that extends across said accommodation space from one of said two side plates of said inner sleeve body to the other one of said two side plates.
